(19) United States
(12) Patent Application Publication
(10) Pub. No.: US 2006/0283329 A1
(43) Pub. Date: Dec. 21, 2006

(54) Coffee pot with freshness timer built into handle

(76) Inventor: Michael Benjamin Ronci, Ormond Beach, FL (US)

Correspondence Address: Michael B. Ronci, 51 Pinehurst Circle, Ormond Beach, FL, 32174, US

(21) Appl. No.: 11/455,184

(22) Filed: Jun. 19, 2006

Related U.S. Application Data
(60) Provisional application No. 60/692,015, filed on Jun. 20, 2005.

(51) Int. Cl. A23L 1/00

(52) U.S. Cl. 99/275

(57) ABSTRACT

A coffee pot with a manually activated timer built into the handle. By resetting the timer at the time of brewing, the timer can be used to keep track of how old the pot of coffee is, and therefore, how fresh it is. While the coffee pot can be used in the home, it is particularly suited for use in restaurants and other settings where multiple coffee pots are present.

### BACKGROUND OF THE INVENTION

1. Field of the Invention

The present invention relates to coffee pots capable of indicating how old, and therefore how fresh their contents are. In particular, this invention describes a coffee pot with a timer built into the handle that can be manually activated at the time coffee is brewed, thereby recording the age of the coffee stored in the pot.

2. Description of the Related Art

The concept of using the age of brewed coffee as a means of determining its freshness has been disclosed in various prior patents. Most refer to systems designed to be used with satellite type brewing systems. In such instances, a single timer which is attached to the coffee brewer itself is invariably used. Since such systems are designed to dispense their brewed product into a single large vat or container, there is no need to have more than just a single timer for keeping track of the age of the brewed coffee.

A few references exist for systems for monitoring the age of an individual pot of coffee. U.S. Pat. No. 5,229,751 employs a complicated sensing system to determine when to activate a timer. U.S. Pat. No. 5,260,914 and U.S. Patent Applications 20050188856 and 20050105395 all describe a removable apparatus that can be attached to the neck of a coffee pot, and which contains a means for keeping track of the age/freshness of the coffee pot's contents. In the case of U.S. Pat. No. 5,260,914 that means is a clock like dial possessing minute and hour hands that can be manually positioned to indicate the time at which the pot's contents lose their freshness. U.S. Patent Applications 20050188856 and 20050105395, on the other hand, use electronic timers.

Therefore, while there exists prior art relating to coffee freshness timers, there exists no prior art that describes a coffee pot with a manually operated freshness timer that is integral to the coffee handle. The novel feature of a timer that is integral to the coffee pot handle and which has a simple and convenient means of manual operation represents a significant improvement in convenience over existing freshness timers.

### BACKGROUND TO THE INVENTION

As with many other industries, the restaurant industry has grown to become very competitive in recent years. In such an environment where businesses that do not keep up with the latest trends and improvements do not last very long, there is enormous pressure among restaurants to seek out improvements in their product to differentiate themselves from their competitors. One area of improvement open to many restaurants is to seek out ways to improve the quality and freshness of their product.

The goal of guaranteeing consistently fresh coffee to customers is a particularly desirable one, and yet, it is a goal which has till now been difficult to achieve for most restaurants. If one examines the typical setup for most restaurants that serve a large amount of coffee, it can be seen why.

Most restaurants that serve large amounts of coffee use commercial coffee brewers that are designed for high volume. A typical commercial coffee brewer contains multiple brewers—usually two, that allow two pots of coffee to be brewed at once. Additionally, they will typically have multiple hot plates to allow multiple coffee pots to be maintained and ready for serving. A typical commercial coffee brewer, such as a number of models made by Bunn Corporation will have 6 hot plates. Most medium to large sized restaurants will contain two or even more coffee stations at various locations within the kitchen. Such a setup ensures that there is a sufficient amount of coffee at hand during peak periods.

The drawback regarding this setup is that there is currently no convenient way to keep track of how old an individual pot of coffee is. It is generally accepted that the shelf life of fresh coffee is approximately one half hour. After this point it generally becomes too bitter for most people's tastes. Without the means to determine the age of an individual pot of coffee, the goal of guaranteeing fresh coffee to ones customers is difficult if not impossible to achieve.

The present invention solves this problem by providing a convenient means of determining the age and therefore freshness of an individual pot of coffee.

### SUMMARY OF THE INVENTION

This invention consists of a modification to the standard coffee pot model that has been in widespread use for years, namely, a partially enclosed reservoir with a single opening on top, capable of receiving and dispensing coffee, and with an attached side handle designed to allow easy pouring of the pot's contents by an operator.

This invention consists of a coffee pot containing a timer built into the handle, with the outer surface of the handle containing a means for manually resetting said timer, as well as a means for displaying the contents of said timer. The timer display reveals the time elapsed since the last manual resetting of the timer. The handle may also contain a status light or lights that are automatically activated by the timer when it reaches preprogrammed time intervals.

### BRIEF DESCRIPTION OF THE DRAWINGS

FIG. 1 is a view of coffee pot and handle.

FIG. 2 is a view of coffee pot handle with inner portion exposed.

FIG. 3 is a view of coffee pot handle with optional battery door shown.

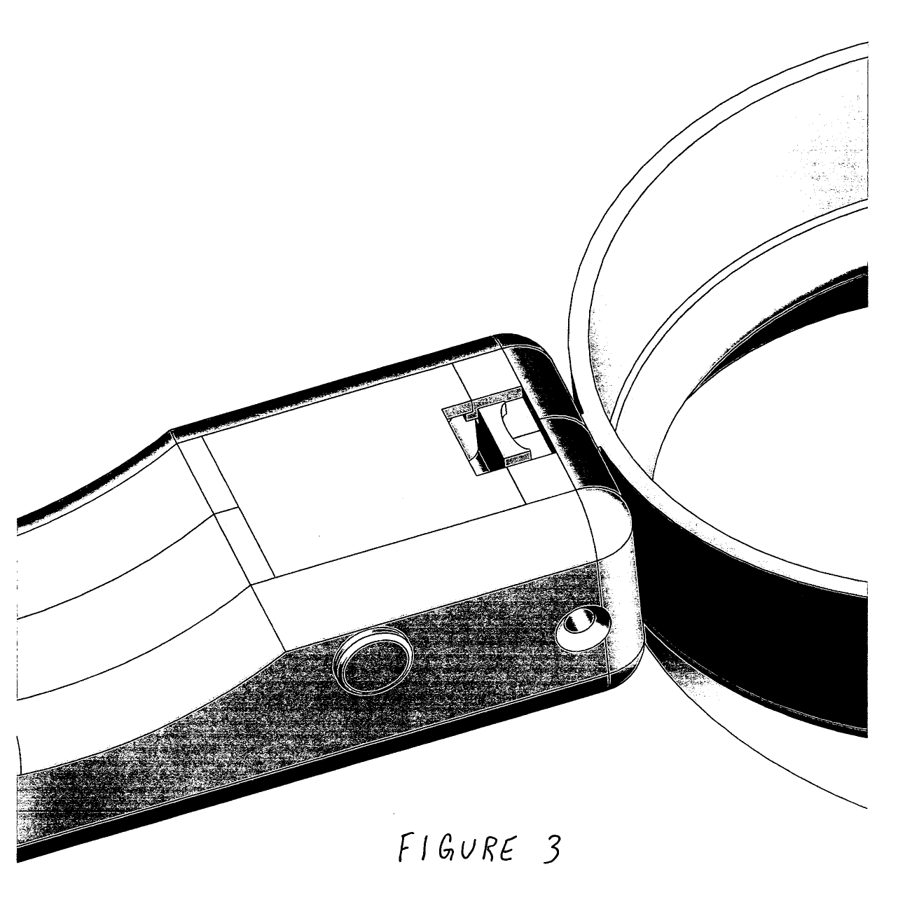

Similar reference characters denote corresponding features consistently throughout the attached drawings.

### DESCRIPTION OF THE PREFERRED EMBODIMENT

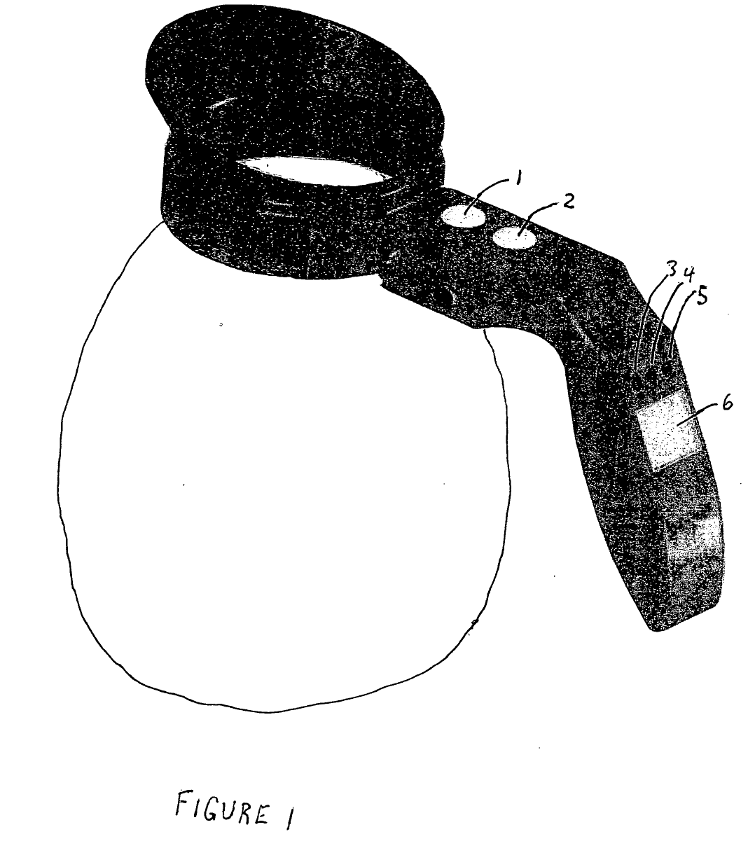

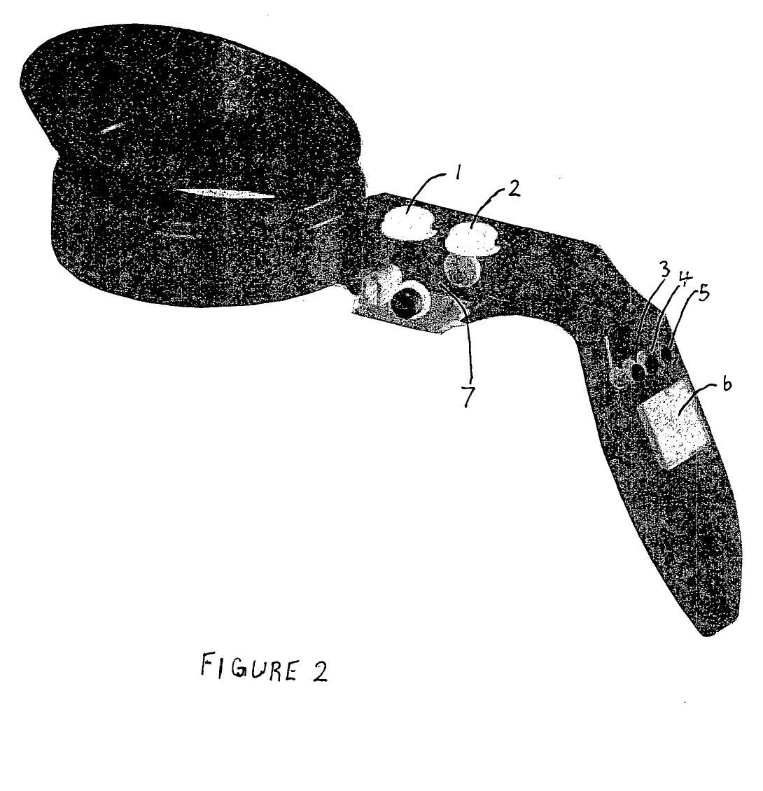

The present invention will now be explained with reference to the preferred embodiment. FIG. 1 shows an external view of the coffee pot which contains a power on/off button 1, a timer reset button 2, status lights 3, 4 and 5, and an LCD timer display 6. FIG. 2 shows a hollowed out area 7 of the handle below the power on/off button 1, and the timer reset button. The hollowed area 7 is the location of an electronic timer which receives its power from a battery also located in area 7. The power on/off button 1 makes contact with a switching mechanism attached to the timer when said on/off button is manually depressed by the operator. The coffee pot can be said to be in one of two states, either on or off. The on state corresponds to the state where power is being supplied to the timer, LCD display and status lights, The off state exists when power is not being supplied to the timer, LCD display or status lights. When the coffee pot is in the off state, manually depressing the power on/off button causes the switching mechanism to activate power to the LCD timer display and status lights. When the coffee pot is in the on state, manually depressing the power on/off button causes the switching mechanism to disconnect power to the timer, LCD timer display and status lights.

To operate the pot, it is necessary to turn it on by pressing the on/off button 1. Doing so causes the LCD to display a time of 0:00 (0 minutes and 0 seconds) and status light 3 to be illuminated. The LCD will display a time of 0:00 indefinitely until either the power is turned off or the timer reset button is depressed. Likewise, status light 3 will remain illuminated indefinitely until either the power is turned off or the LCD display displays a time greater than 15:00 (15 minutes and 0 seconds).

Once the coffee pot has been turned on, it can be used to keep track of the freshness of any coffee brewed and stored therein. This is done by manually depressing the timer reset button 2 at the start of the brew cycle. Depressing the timer reset button causes the timer to begin counting time in minutes and seconds and to display said time via the LCD timer display 6. Status light 3 which radiates a green light remains illuminated until the timer display reaches 15 minutes. At this point, status light 3 shuts off and status light 4, previously off, turns on. Status light 4 radiates an amber light, and remains illuminated until the timer display reaches 30 minutes, at which point it shuts off, and status light 5, which had been off, turns on. Status light 5 radiates a red light, and remains illuminated until either the timer reset button is depressed, or the power on/off button is depressed. The timer meanwhile, continues counting until 59:59 (59 minutes and 59 seconds) are reached. At this point, the LCD timer display continues to display 59:59 indefinitely until either the timer reset button is depressed or the power on/off button is depressed.

While the above description describes one embodiment of the present invention, it is to be understood that the present invention is not limited to the embodiment described above, but encompasses any and all embodiments within the scope of the claims listed. The preferred embodiment of the present invention disclosed herein is intended to be illustrative only and is not intended to limit the scope of the invention.

I claim:

1. A coffee decanter containing a handle for pouring coffee, said handle having a hollowed out and enclosed inner portion containing a mechanical timer.

2. A coffee decanter containing a handle for pouring coffee, said handle having a hollowed out and enclosed inner potion containing an electronic timer

3. Coffee decanter described in claim 2 where electronic timer is connected to a power source such as a battery.

4. Coffee decanter described in claim 3 where electronic timer is connected to a means for displaying the status of said electronic timer.

5. Coffee decanter described in claim 4 whereby the electronic timer status display consists of an LCD (liquid crystal display) capable of displaying the status of the timer in minutes.

6. Coffee decanter described in claim 5 whereby the LCD timer display is capable of displaying the status of the timer in intervals of time smaller than minutes (e.g. seconds).

7. Coffee decanter described in claim 6 whereby the enclosed timer is connected to a means for resetting said timer.

8. Coffee decanter described in claim 7 whereby means for resetting timer consists of a depressible button protruding from the surface of the handle, said button capable of being manually depressed with said depression of said button causing resetting of the electronic timer to zero.

9. Coffee decanter described in claim 8 whereby the handle contains a status light.

10. Coffee decanter described in claim 9 where said status light is capable of changing colors in response to signals sent from the timer at specific time intervals.

11. Coffee decanter described in claim 8 whereby the handle contains multiple status lights.

12. Coffee decanter described in claim 11 whereby said status lights display different colors, whereby each status light is either on or off, and whereby each status light is capable of being activated by a signal sent from the timer at a specific time interval.
